(19) United States
(12) Patent Application Publication
(10) Pub. No.: US 2017/0137311 A1
(43) Pub. Date: May 18, 2017

(54) SYSTEM AND METHOD OF TREATING ORGANIC MATERIAL

(71) Applicant: reNature, Inc., Tempe, AZ (US)

(72) Inventors: Todd Fernandez, Lafayette, IN (US); Evan Taylor, Phoenix, AZ (US)

(21) Appl. No.: 15/323,713

(22) PCT Filed: Jul. 1, 2015
(86) PCT No.: PCT/US15/38897

§ 371 Date: Jan. 3, 2017

Related U.S. Application Data
(60) Provisional application No. 62/020,914, filed on Jul. 3, 2014.

(51) Int. Cl. C02F 11/02; C02F 11/00; C02F 11/06; C02F 1/78

(52) U.S. Cl. CPC C02F 11/02; C02F 1/78; C02F 11/004; C02F 11/06; C02F 2101/322

(57) ABSTRACT

A system and method of treating organic material using active species are disclosed. The system and method can be used to treat the organic material before introducing the organic material to a biodigestion reactor. The active species can include, for example, ozone, and can be used to, for example, kill microorganisms, sterilize the organic material, reduce volatile organic compounds, degrade or break down toxins and/or pharmaceutical compounds in the organic material, and/or increase the surface are of the organic material.

### CROSS-REFERENCE TO RELATED APPLICATIONS

This application claims the benefit of U.S. Provisional Patent Application Ser. No. 62/020,914, entitled SYSTEM AND METHOD OF TREATING ORGANIC MATERIAL, and filed Jul. 3, 2014, the contents of which are hereby incorporated herein by reference to the extent such contents do not conflict with the present disclosure.

### FIELD OF DISCLOSURE

The present disclosure generally relates to systems and methods of treating organic material. More particularly, the disclosure relates to systems and methods of treating organic material with an active species, such as an oxidant.

### BACKGROUND OF THE DISCLOSURE

Organic material, such as organic waste (e.g., food, yard waste, and the like) often ends up in landfills, where it adds no value, and potentially produces undesirable products, such as methane gas. To mitigate production of undesirable products in landfills, some communities have instituted procedures for separating organic waste material and composting the organic waste material. Although these procedures can work relatively well in some cases, composting can require a relatively large amount of space for the material to be composted, composting is relatively slow and inefficient, and composting can result in undesirable odors, particularly when meat or dairy products are being composted.

Accordingly, improved methods and systems for treating organic material that are more efficient and that produce relatively little odor, even when products such as meat and dairy products are being treated, are desired.

### SUMMARY OF THE DISCLOSURE

Various embodiments of the present disclosure relate to systems and methods for treating organic material. While the ways in which various embodiments of the present disclosure address drawbacks of prior techniques to treat such materials are discussed below, in general, various embodiments of the disclosure provide systems and methods that use an active species to treat the organic material. Use of the active species can reduce odors that might otherwise be associated with the systems and methods to treat organic waste and/or can be used to kill or control microorganisms associated with the organic material prior to further processing.

In accordance with exemplary embodiments of the disclosure, a system for treatment of organic material includes an active species source and a biodigestion reactor system, wherein organic material is treated with an active species from the active species source prior to entering the biodigestion reactor system and/or prior to further processing. The organic material can include, for example, organic material from one or more of the group consisting of food waste, paper, cardboard, animal waste, and other biodegradable organic material. In accordance with various aspects of these embodiments, treatment with the active species reduces odors associated with the organic material, reduces a number of microorganisms on the organic material, sterilizes the organic material, breaks down the organic material, degrades toxins and pharmaceuticals into safe or less harmful compounds, and/or increases a surface area of the organic material. In accordance with further aspects, the active species includes an oxidant, such as ozone. The ozone can be formed using, for example, an ozone generator operating at about atmospheric pressure that uses ultraviolet light or coronal discharge to form ozone in air. In accordance with further aspects, the system includes a conveyor or other means to move the organic material into the biodigestion reactor and the organic material is treated while on the conveyor or similar means. In accordance with yet further aspects, after exposure to the active species, a concentration active species on or proximate the organic material is reduced—e.g., to near ambient concentrations—prior to the organic material entering the biodigestion reactor. Additionally or alternatively, oxygen in the system and/or the microorganisms can breakdown the toxins and/or pharmaceuticals.

In accordance with additional exemplary embodiments of the disclosure, a method of treating organic material includes the steps of providing organic material; exposing the organic material to an active species to, e.g., perform one or more of the following: kill microorganisms, sterilize the organic material, increase a surface area of the organic material, break down the organic material, degrade toxins and/or pharmaceuticals, and reduce volatile organic compounds; and providing organic material treated with the active species to a biodigestion reactor. In accordance with exemplary aspects of these embodiments, the step of providing organic material includes providing one or more materials selected from the group consisting of food waste, paper, cardboard, animal waste, and other biodegradable organic material. In accordance with further aspects, the step of exposing the organic material to an active species comprises exposing the organic material to an oxidant, such as ozone. The ozone can be formed, for example, using an atmospheric pressure ozone generator. The method can also include a step of allowing the active species concentration to reduce—e.g., to near ambient conditions—prior to the step of providing. Additionally or alternatively, oxygen and/or microorganisms (e.g., in one or more of the reactors) can be used to breakdown toxins and/or pharmaceuticals initially contained in the organic feed material.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates a system in accordance with various exemplary embodiments of the disclosure.

FIG. 2 illustrates a method in accordance with additional exemplary embodiments of the disclosure.

It will be appreciated that elements in the figures are illustrated for simplicity and clarity and have not necessarily been drawn to scale. For example, the dimensions of some of the elements in the figures may be exaggerated relative to other elements to help to improve the understanding of illustrated embodiments of the present disclosure.

### DETAILED DESCRIPTION OF EXEMPLARY EMBODIMENTS OF THE DISCLOSURE

The description of exemplary embodiments provided below is merely exemplary and is intended for purposes of illustration only; the following description is not intended to limit the scope of the disclosure or the claims. Moreover, recitation of multiple embodiments having stated features is not intended to exclude other embodiments having additional features or other embodiments incorporating different combinations of the stated features.

As set forth in more detail below, exemplary methods and systems as described herein can be used to treat organic material to, for example, form enriched products that can be used as soil amendments and/or fertilizer.

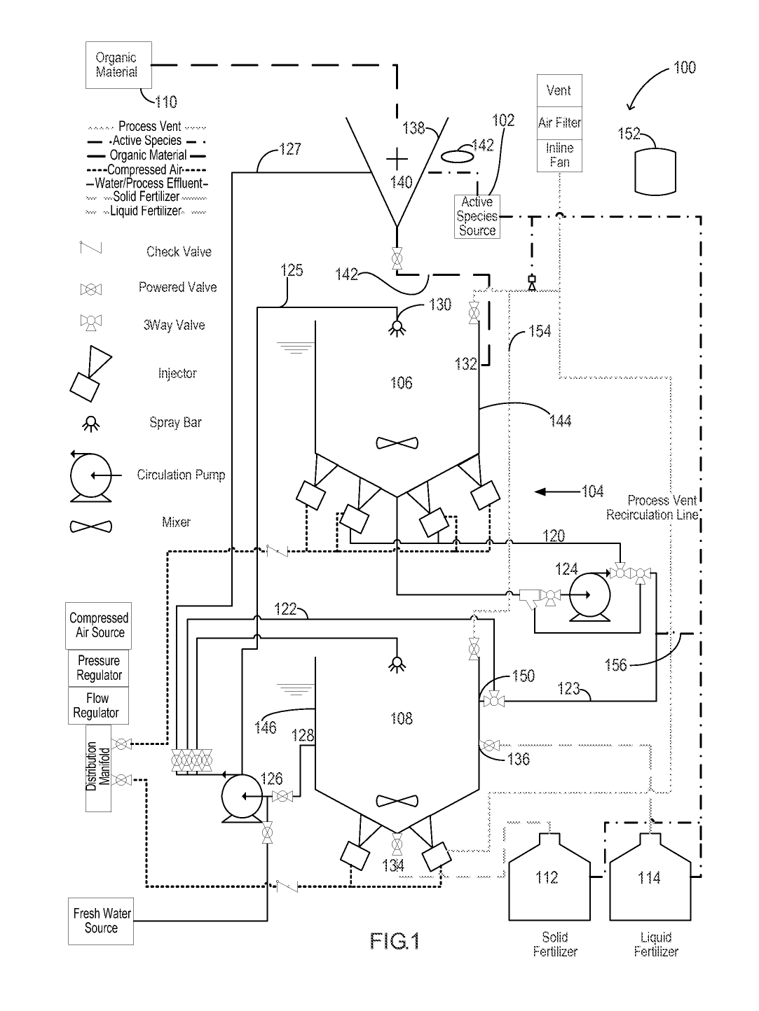

FIG. 1 illustrates an exemplary system 100 in accordance with various embodiments of the disclosure. System 100 includes an active species source 102 and a biodigestion reactor system 104. Biodigestion reactor system 104 can include multiple reactors or stages. In the illustrated example, biodigestion reactor system 104 includes a first biodigestion reactor 106 and a second biodigestion reactor 108. Biodigestion reactor systems can include any suitable number of reactors or stages.

During operation of system 100, organic material 110 is converted into enriched products, such as solid and/or liquid products suitable for use as fertilizer, using biodigestion reactor system 104. More particularly, organic material 110 is treated with active species (e.g., an oxidant, such as ozone) from active species source 102. Treated organic material is then transferred to first biodigestion reactor 106 for treatment, and, in the illustrated example, to second biodigestion reactor 108 for further treatment. Enriched products can be collected in vessels 112 (for, e.g., solids) and 114 (for, e.g., liquids).

Organic material 110 can include, for example, one or more materials from the group consisting of food waste, paper, cardboard, animal waste, and other biodegradable organic material. By way of particular examples, organic material 110 includes food waste, which may include meat, dairy, and/or vegetation.

Active species source 102 can include any suitable source of active species. By way of examples, active species source includes an oxidant source. The oxidant source can be an ozone generator. Exemplary ozone generators suitable for use with the present disclosure include coronal discharge ozone generators and ultraviolet light ozone generators. Exemplary ozone generators can operate at or near atmospheric pressure. The exemplary generators can produce, for example, greater than 100 ppb ozone in air, greater than 500 ppb ozone in air, greater than 1 ppm ozone in air, or greater than 2 ppm ozone in air. By way of specific examples, active species source can include one or more of coronal discharge and ultraviolet light ozone generators. In accordance with various aspects of these examples, ozone can be generated by drawing (e.g., via a pump) air though a reaction chamber of an active species source, and energizing the oxygen atoms—for example, by using ultraviolet light or a coronal discharge to increase a concentration of active species in air. For example, a concentration of ozone can increase from about 10 ppb to greater than 100 ppb ozone in air, greater than 500 ppb ozone in air, greater than 1 ppm ozone in air, or greater than 2 ppm ozone in air. The air with increased active species (e.g., ozone) can then be pumped toward organic material 110 to treat the organic material.

The active species can be used to reduce odors that might otherwise be associated with organic material 110, to sterilize the organic material, to break down organic material 110, to increase a surface area of organic material, to kill microorganisms on a surface of organic material 110 to reduce a number of microorganisms on the surface, to break down toxins (e.g., herbicides, such as chlorinated herbicides, pesticides, such as organochlorine pesticides, and/or fungicides) and/or pharmaceutical compounds, and the like, and/or break down volatile organic compounds in or associated with the organic material. Reducing the number of microorganisms has an added benefit of providing additional process control during processing of organic material 110 in, for example, reactors 106 and 108 of biodigestion system 104. Further, as illustrated, active species from source 102 can be used to treat product(s) from vessels 112 and/or 114, and/or to treat material in line 156.

System 100 can be configured, such that a half-life of the active species is relatively short, such that the active species do not undesirably interfere with downstream processes. For example, the half-life of the active species can be less than 2 hours, less than 1.5 hours, less than 1 hour, about 30 minutes or less, or be about 30 to about 60 minutes.

Biodigestion reactors 106, 108 can include any suitable biodigestion reactor. By way of examples, biodigestion reactors 106, 108 can be formed of metal, such as stainless steel or plastic, such as high density polyethylene. Reactors 106, 108 can include one or more microorganisms, such as one or more inoculants, such as bacteria and/or fungi to break down the organic material into one or more products. Biodigestion in biodigestion reactors 106, 108 can include aerobic digestion of the organic material. The products can be used, for example, as soil amendments and/or fertilizer.

System 100 also includes one or more circulation lines 120, 122, 123, 125, 127 which can include one or more circulation pumps 124, 126. Material from second biodigestion reactor 108 (e.g., received from a first output 128 of second biodigestion reactor 108) can be provided to first biodigestion reactor 106 (e.g., a second input 130) using line 125 and pump 126. Similarly, material from second biodigestion reactor 108 can be provided to first biodigestion reactor 106 using line 120 and pump 124. Material circulated from second biodigestion reactor 108 to first biodigestion reactor 106 can be used to control reactions and reaction rates in both first biodigestion reactor 106 and second biodigestion reactor 108. Controlling the reactions in the respective biodigestion reactors can, in turn, allow control of products and nutrient concentrations from biodigestion reactors system 104. Furthermore, a location of output 136 and/or input 150 can be used to control desired and/or undesired reactions within the respective biodigestion reactors. For example, an output 136 may be raised or lowered depending on desired material to be circulated to first biodigestion reactor 106. Similarly, input 132 and/or 130 can be moved to “feed” one or more regions within first biodigestion reactor 106. System 100 can also include automated or manual back flush systems on one or more of the lines to prevent, mitigate, or reverse clogging in various lines of the system to or from reactors 106, 108. In the illustrate example, line 127 can be used to provide liquid from second biodigestion reactor 108 to grinder 140 to reduce an amount of water that might otherwise be added to system 100 to facilitate grinding of organic material 110. The circulated material in line 127 can also facilitate breakdown of organic material. Although not illustrated, material from first biodigestion reactor 106 can similarly be used to treat organic material 110. Further, exemplary systems can use feedback from one or more of circulation pumps 124, 126 to manipulate one or more process parameters (e.g., dilution of material within the reactor (e.g., dilute material in reactor 106 with material from reactor 108), change pump speed, or the like) of first biodigestion reactor 106 and/or second biodigestion reactor 108.

System 100 can also include gas circulation lines 154 to allow for gas produced from one reactor to be introduced into another reactor. For example, NH₃, CO₂, NOₓ, or the like can be fed from biodigestion reactor 106 to biodigestion reactor 108 or vice versa or to a final product in vessel 112 or 114. Additionally or alternatively, gas output from a first biodigestion reactor can be fed to another first biodigestion reactor and/or from a second biodigestion reactor to another second biodigestion reactor. Feeding gasses from one reactor to another can be used to control nutrient content, a pH within a reactor, and/or promote or inhibit growth of particular microorganisms or of digestion or organic material.

As noted above, nutrient-enriched products can be collected in vessels 112, 114. For example, (e.g., solid) products from a second output 134 of second biodigestion reactor 108 can be collected in vessel 112. And, (e.g., liquid) products can be collected in vessel 114 from a third output 136 of second biodigestion reactor 108. A composition and/or concentration of the products can be based on a location of the second and/or third outputs. The active species source 102 can be used to treat one or more products in vessels 112, 114 and/or material between biodigestion reactors in, for example, line 156. For example, if it is desired to stop or mitigate growth of one or more microorganisms in the product(s), the active species source can be used to reduce a number of microorganisms in the product(s). Additionally or alternatively, the product(s) can be subjected to a pasteurization process.

The liquid and solid products can include nutrients that can be used as soil amendments. Various nutrients include biologically available nutrients, such as one or more of B, Ca, Cu, Fe, Mn, Mg, Mo, N, P, K, Na, Zn, one or more chlorides, one or more sulfates, one or more nitrates, one or more carbonates, fulvic acid, and humic acid.

System 100 can also include a hopper 138 to hold organic material. System 100 can also include a grinder 140 to cut organic material 110 into smaller pieces (e.g., pieces having a largest dimension of about 2000 microns for pre-processing then down to 300-600 microns for typical agricultural markets, 100-200 microns for retail markets, and 10-50 microns for hydroponics/aeroponics markets). Use of grinder 140 can increase a surface area of organic material available for reaction in biodigestion system 104. In some cases, the organic material is treated with active species after (e.g., immediately after) the grinding process.

System 100 can also include an evaporator (not illustrated) coupled to one or more outputs of a biodigestion reactor, such as second biodigestion reactor 108.

Exemplary systems, such as system 100, can also include one or more sensors. For example, system 100 can include an active species sensor 142. Active species sensor 142 can be located anywhere, such as between active species source 102 and first input 132.

System 100 can additionally or alternatively include one or more of an NH₃ sensor, a dissolved oxygen sensor, a pH sensor, a CO₂ sensor, a temperature sensor, an NOₓ sensor, a humidity sensor, and a pressure sensor coupled to one or more of the first biodigestion reactor 106 and the second biodigestion reactor 108. The sensors can be used to monitor reactions within the respective biodigestion reactors and one or more process parameters, such as mixing rate, circulation rate, amount of microorganisms, types and species of microorganisms, and the like, and can be automatically or manually manipulated based on sensor values. Furthermore, one or more sensors and/or sensor types can be located at various locations (e.g., heights) of the first biodigestion reactor vessel 144 and/or second biodigestion reactor vessel 146 to monitor various reactions at the respective locations of the biodigestion reactors.

System 100 can also include one or more breeder reactors 152. The breeder reactors can be used to incubate or grow one or more microorganisms for use in one or more of first biodigestion reactor 106 and second biodigestion reactor 108. Breeder reactor 152 can include suitable nutrient, water, active species (e.g., ozone), and/or air supplies.

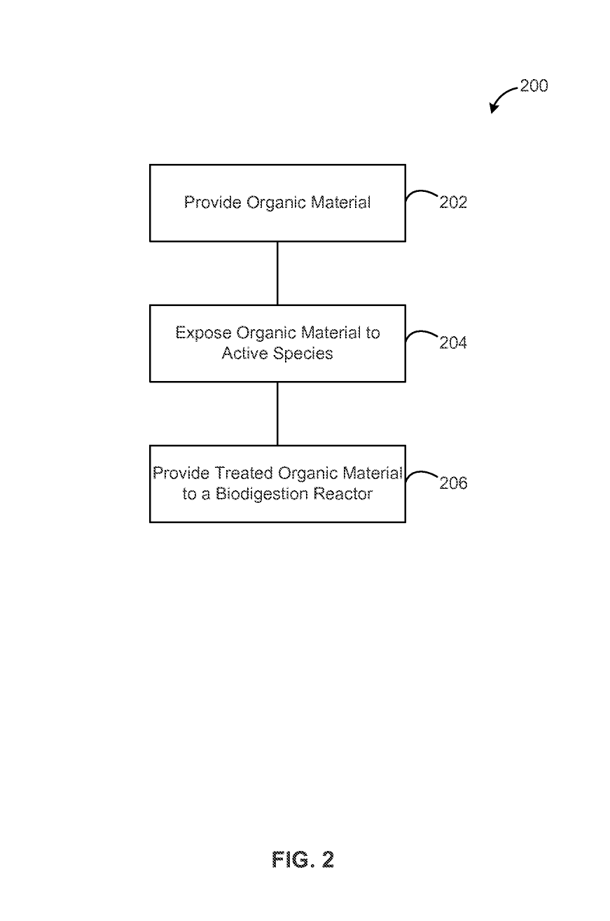

FIG. 2 illustrates a method 200 of treating organic material in accordance with exemplary embodiments of the disclosure. Method 200 includes the steps of providing organic material (step 202), exposing the organic material to an active species (step 204), and providing organic material treated with the active species to a biodigestion reactor (step 206).

During step 202, any suitable organic material, such as the exemplary organic material 110, can be provided. By way of example, food waste can be provided during step 202. The organic material can be ground to a desired size, as described above.

During step 204, the organic material is exposed to active species. Step 204 can be configured to reduce an amount of microorganisms present on the organic material that might otherwise cause odors. Additionally or alternatively, step 204 can be configured to sterilize the organic material, to reduce odors that might otherwise be associated with organic material 110, to break down organic material 110, to increase a surface area of organic material, to break down toxins and/or pharmaceuticals, and/or to break down volatile organic compounds in or associated with the organic material. All organic material being processed can be exposed to the active species during step 204. Alternatively, only a portion of the organic material (e.g., only primarily solids, or only primarily meats and dairy products) can be treated with active species.

As used herein, “primarily” means material comprising more than 50 percent, more than 60 percent, more than 75 percent, or more than 90 percent of the type of material. The active species can be from active species source 102.

A time of exposing the organic material to the active species can vary according to a number of factors, including an amount of organic material, a type of organic material, size of the organic material (e.g., size of pieces coming from grinder/hopper system 120), and the like. By way of examples, the organic material can be exposed to the active species for greater than 15 minutes, greater than 20 minutes, greater than 30 minutes, greater than 1 hour, or greater than two hours, or about 1 minute to about 10 hours, about 10 minutes to about 6 hours, or about 20 minutes to about 40 minutes.

During step 204, the organic material can be exposed to the active species in a way that allows the active species to decay prior to the organic material entering a biodigestion reactor, such as reactor 106 or 108. Allowing the active species to decay—e.g., by at least about 95% or about 4 half-lives—mitigates risks associated with the active species affecting microorganisms used in the biodigestion reactors. During step 204, the active species can be used in a variety of locations. For example, with reference to FIG. 1, the organic material can be exposed to the active species prior to entering grinder hopper system 120, in grinder hopper system 120, and/or after grinder hopper system 120 and before biodigestion reactor 106. Further, exhaust from system 100 can be treated with the active species.

At step 206, organic material treated with the active species is provided to one or more biodigestion reactors, such as biodigestion reactor 106. As noted above, in accordance with various aspects of these exemplary embodiments, an amount of active species is allowed to substantially reduce—e.g., to near ambient concentrations—prior to the organic material entering the first biodigestion reactor. As used herein, near ambient conditions means condition of local air quality within acceptable tolerance levels.

The subject matter of the present disclosure includes all novel and nonobvious combinations and subcombinations of the various systems, components, and configurations, and other features, functions, acts, and/or properties disclosed herein, as well as any and all equivalents thereof.

1. A system for treatment of organic material, the system comprising:
an active species source; and
a biodigestion reactor system,
wherein organic material is treated with an active species from the active species source prior to entering the biodigestion reactor system.

2. The system of claim 1, wherein the active species source comprises an ozone generator.

3. The system of claim 1, further comprising a conveyor to move the organic material to the biodigestion reactor system.

4. The system of claim 1, wherein the ozone generator operates at about atmospheric pressure.

5. The system of claim 1, further comprising an active species sensor between the active species source and the biodigestion reactor system.

6. The system of claim 1, wherein the active species kills microorganisms on the organic material.

7. The system of claim 1, wherein the active species increases a surface area of the organic material.

8. The system of claim 1, wherein the active species break down volatile organic compounds in the organic material.

9. The system of claim 1, wherein the active species break down one or more of toxins and pharmaceuticals.

10. The system of claim 1, wherein the organic material is selected from one or more materials from the group consisting of food waste, paper, cardboard, animal waste, and other biodegradable organic material.

11. The system of claim 1, wherein a half-life of the active species is less than 2 hours.

12. The system of claim 1, wherein the active species comprises greater than 100 ppb ozone in air or greater than 1 ppm ozone in air.

13. The system of claim 1, wherein the organic material is exposed to the active species for about 1 minute to about 12 hours.

14. A method of treating organic material, the method comprising the steps of:
providing organic material;
exposing the organic material to an active species to perform one or more of the following: kill microorganisms, sterilize the organic material, increase a surface area of the organic material, break down toxins , break down pharmaceuticals, and reduce volatile organic compounds; and
providing organic material treated with the active species to a biodigestion reactor.

15. The method of claim 14, wherein the step of providing organic material comprises providing one or more from the group consisting of food waste, paper, cardboard, animal waste, and other biodegradable organic material.

16. The method of claim 14, wherein the step of exposing the organic material comprises exposing the organic material to ozone.

17. The method of claim 16, wherein the ozone is generated from one or more of a coronal discharge of air and ultraviolet light.

18. The method of claim 14, wherein substantially all of the ozone, from the step of exposing the organic material to ozone, dissipates or decays prior to the step of exposing the organic material.

19. The method of claim 14, wherein a time of the step of exposing the organic material ranges from about 1 minute to about 10 hours, about 10 minutes to about 6 hours, about 20 minutes to about 40 minutes, or greater than 30 minutes.

20. The method of claim 14, wherein a half-life of the active species is less than 2 hours.

21. (canceled)

22. (canceled)

23. (canceled)
